(19) United States
(12) Patent Application Publication
(10) Pub. No.: US 2024/0084122 A1
(43) Pub. Date: Mar. 14, 2024

(54) FLUID-SYSTEM COMPONENTS

(71) Applicant: SOLVAY SPECIALTY POLYMERS ITALY S.P.A., Bollate (Milano) (IT)

(72) Inventors: Serena Carella, Parabiago (IT); Giulio Brinati, Milan (IT); Marco Avataneo, Milan (IT)

(73) Assignees: SOLVAY SPECIALTY POLYMERS ITALY S.P.A., Bollate (Milano) (IT); SOLVAY SPECIALTY POLYMERS ITALY S.P.A., Bollate (Milano) (IT)

(21) Appl. No.: 17/767,869

(22) PCT Filed: Oct. 2, 2020
(86) PCT No.: PCT/EP2020/077722

§ 371 Date: Apr. 8, 2022

(30) Foreign Application Priority Data
Oct. 9, 2019 (EP) 19202277.0

(51) Int. Cl. C08L 27/18

(52) U.S. Cl. CPC C08L 27/18; C08L 2203/18; C08L 2205/02

(57) ABSTRACT

The present invention relates to a fluid-system component comprising a thermoplastic polymeric composition, said composition comprising one or more semi crystalline polymer, said semi crystalline polymer comprising recurring units derived from ethylene (E) and at least one of chlorotrifluoroethylene (CTFE) and tetrafluoroethylene (TFE); said semi crystalline polymer having a heat of fusion of less than 35 J/g [polymer (A)], and wherein said thermoplastic polymeric composition when subject to the extraction test described herein has a leeching of less than 50 ppb preferably less than 10 ppb for each of Ca, Fe, K, Na, Zn, Ti, Sn, Ce, Cu, Zr, Bi, Si, Al, Sb.

### TECHNICAL FIELD

This application claims priority to the European patent Application Nr 19202277.0 filed on 9 Oct. 2019, the whole content of this application being incorporated herein by reference for all purposes.

The present invention relates to fluid-system components, particularly suitable for systems using pure and ultrapure fluids, which can find application in particular in the electronics industry, for example in the manufacturing of semiconductor devices.

### BACKGROUND ART

High and Ultra-purity standards are increasing their importance in several technological fields including chemistry, sanitation, electronics etc. A technology area where the specifications for ultra-purity components are increasingly stringent is the electronics industry, in particular the semiconductors industry. Fluids such as gas and liquids of different types are used in many processes in semiconductor manufacturing for different purposes (temperature control, etching, as solvents, for creating protected atmospheres and so on).

Semiconductor manufacturers must use fluids, and fluid distribution systems with a particularly high degree of purity to avoid even the slightest degree of contamination from metals, metal ions, organic compounds, particles and the like.

The present invention is concerned with the components of a fluid distribution system (“fluid-system components”) which is suitable for pure and ultrapure fluids which can find application in an electronics manufacturing facility e.g. a semiconductor manufacturing facility.

Ultrapure fluids commonly used in the electronics industry include ultrapure water, ultrapure hydrofluoric acid, ultrapure hydrogen peroxide, ultrapure isopropyl alcohol, ultrapure ammonium hydroxide and others. The purity grade of such fluids is defined by industry standards, depending on the specific application, under the ASTM or SEMI norms which are known to the skilled person. The respect of these standards is necessary in order to prevent contamination of electronics and semiconductor materials. For example widely used requirements for ultra-pure water quality are documented by ASTM D5127 “Standard Guide for Ultra-Pure Water Used in the Electronics and Semiconductor Industries” and SEMI F63 “Guide for ultrapure water used in semiconductor processing”.

Fluid-system components which are used to transport and contain ultrapure fluids must also respect purity standards. Specific industry standards have been developed to define which materials can be used in fluid-system components for handling ultrapure fluids. In particular the standards defined in the norm “SEMI F-57” has been broadly adopted by the semiconductor industry even if in some cases different requirements, which can be more or less stringent than the SEMI F-57 norm have been imposed depending on the specific application.

The SEMI F-57 standard considers 5 categories of contaminants:
a) total organic carbon (TOC)
b) 7 ionic contaminants
c) 16 metallic contaminants
d) particles
e) surface roughness.

The SEMI F-57 standard provides for maximum levels for each contaminant a)-d) typically in μg/m² and a measure for surface roughness. The levels of contaminants are measured in μg/m² because typically the contaminant are measured trough extraction tests which are conducted treating a surface made of the material with the solvent of choice and the extracted amount is directly proportional to the treated surface. (Ultrapure Water—May/June 2012 p. 1-5, ISSN:0747-8291).

As mentioned above fluid distribution systems are typically made of out of a number of different fluid-system components joined together. Some fluid system components are described for example in the Saint Gobain Process System Website under “electronics” at

www.processsystems.saint-gobain.com.
In order to respect the required standards, fluid-system components for the semiconductor industry are typically made from selected materials which ensure the extreme purity which is required by the standards. PTFE (polytetrafluoroethylene) and PVDF (polyvinylidene fluoride) have been materials of choice for these applications so far. In particular PVDF is preferred because it is easier to extrude and mould than PTFE being workable at lower temperature. These materials are resistant to most chemicals, have high strength, high rigidity, are resistant to hot and cold temperature, are compatible with most chemicals and, more importantly, can be produced with smooth surfaces and with a purity level which is sufficient to meet the ultra-purity standards.

Nevertheless there is a continuous demand in the industry for new materials for making fluid-system components which can be processed at even lower temperatures, have similar desirable properties to PTFE and PVDF and which can pass even more stringent purity tests.

### SUMMARY OF INVENTION

In one aspect, the present invention relates to a fluid-system component comprising a thermoplastic polymeric composition, said composition comprising one or more semi crystalline polymer, the semi crystalline polymer comprising recurring units derived from ethylene (E) and at least one of chlorotrifluoroethylene (CTFE) and tetrafluoroethylene (TFE) said semi crystalline polymer having a heat of fusion of less than 35 J/g [polymer (A)] and wherein said thermoplastic polymeric composition when subject to the extraction test described herein has a leeching of less than 50 ppb, preferably less than 10 ppb for each of Ca, Fe, K, Na, Zn, Ti, Sn, Ce, Cu, Zr, Bi, Si, Al, Sb.

In another aspect, the present invention relates to a method of making such fluid system components.

In another aspect the present invention relates to method of transporting or containing ultrapure fluids including the step of contacting said ultrapure fluids with one or more of such fluid-system component.

### DESCRIPTION OF EMBODIMENTS

Fluid systems in an electronics manufacturing facility are typically used to distribute and contain ultrapure fluids as described in the background section of the present application.

The term “fluid-system component” according to the present invention include in general each of the components defining the path for fluids to be transported, collected and used in a fluid distribution system for example in an electronics manufacturing facility, particularly in a semiconductors manufacturing facility. Fluid-system components include for example pipes (rigid and flexible), valves, fittings, pumps, manifolds, regulators, pressure regulators, static mixers, gauge protectors, filter housings, o-rings, wet benches.

Fluid-system components according to the present invention comprise a thermoplastic polymeric composition, said composition comprising one or more semi crystalline polymer, the semi crystalline polymer comprising recurring units derived from ethylene (E) and at least one of chlorotrifluoroethylene (CTFE) and tetrafluoroethylene (TFE) said semi crystalline polymer having a heat of fusion of less than 35 J/g [polymer (A)] wherein said thermoplastic polymeric composition when subject to the extraction test described herein has a leeching of less than 50 ppb, preferably less than 10 ppb for each of Ca, Fe, K, Na, Zn, Ti, Sn, Ce, Cu, Zr, Bi, Si, Al, Sb.

The thermoplastic composition of the invention comprises one or more semi crystalline polymer (A) characterized by a low heat of fusion which indicates a low level of crystallinity. Preferably the thermoplastic polymeric composition comprises at least 95% wt, more preferably at least 99%, and even more preferably consists of said one or more semi crystalline polymer (A).

Preferably said one or more semi crystalline polymer (A) comprises more than 95% in moles of recurring units derived from ethylene, CTFE and TFE. More preferably the one or more polymer (A) comprises an amount of recurring units derived from ethylene of less than 50% moles, preferably of less than 48% moles, more preferably of less than 45% moles, as this enable achieving improved properties due to the fluoromonomer components.

Polymers (A) suitable in the present invention typically comprise:
(a) from 30 to 48%, preferably from 35 to 45% by moles of ethylene (E);
(b) from 52 to 70%, preferably from 55 to 65% by moles of chlorotrifluoroethylene (CTFE), tetrafluoroethylene (TFE) or mixture thereof; and
(c) from 0 to 5%, preferably from 0 to 2.5% by moles, based on the total amount of monomers (a) and (b), of one or more fluorinated and/or hydrogenated comonomer(s). Preferably the comonomer is a hydrogenated comonomer selected from the group of the (meth)acrylic monomers. More preferably the hydrogenated comonomer is selected from the group of the hydroxyalkylacrylate comonomers, such as hydroxyethylacrylate, hydroxypropylacrylate and (hydroxy)ethylhexylacrylate, and alkyl acrylate comonomers, such as n-butyl acrylate.

Among polymers (A), ECTFE copolymers, i.e. copolymers of ethylene and CTFE and, optionally, a third monomer, as above detailed, are preferred.

Polymers (A) suitable in the composition of the invention preferably possess a melting temperature between 150 and 230° C., preferably between 170 and 220° C., more preferably between 175 and 215° C. This melting temperature range is linked to the relatively low level of crystallinity of these polymers which is a consequence of the excess of one of the monomer type, typically of the fluorine containing monomer with respect to the ethylene monomer in the one or more polymer (A). It is in fact known that ETFE and ECTFE co-polymers have the higher crystallinity when the molar ratio is 50/50 and their crystallinity, and consequently their melting temperature quickly decreases while increasing or decreasing the level of ethylene with respect to the 50/50 ratio.

The melting temperature is determined by Differential Scanning calorimetry (DSC) at a heating rate of 10° C./min, according to ASTM D 3418.

As mentioned above the heat of fusion in particular is a good measure of the crystallinity of the polymer. The heat of fusion of polymer (A) is determined by Differential Scanning calorimetry (DSC) at a heating rate of 10° C./min, according to ASTM D 3418.

The polymer (A) possess a heat of fusion of less than 35 J/g, preferably of at most 30 J/g, more preferably of at most 25 J/g.

Nevertheless, it is essential for polymer (A) of being a semi-crystalline polymer, i.e. a polymer having a detectable melting temperature when determined according to ASTM D 3418. Without lower limit for heat of fusion being critical, it is nevertheless understood that polymers (A) will generally possess a heat of fusion of at least 1 J/g, preferably of at least 2 J/g, more preferably of at least 5 J/g.

For example an ECTFE polymer with a 50/50 molar ratio such as Halar® H901 from Solvay, typically has a melting temperature of about 242° C. and in order to be effectively worked (e.g. moulded or extruded) it has to be heated further at a typical processing temperature of about 275° C. At this processing temperature in fact it reaches a melt flow rate of about 1 g/min (under 2.16 kg) which allows the material to be worked with conventional equipment.

On the other hand an ECTFE copolymer manufactured in the same way but according to the present invention, with 54% of CTFE and 46% of Ethylene, has a melting temperature of about 205° C. and reaches a melt flow rate of about 1 g/min (under 2.16 kg) at about 230° C. at which temperature it can be worked into a finished product.

While this difference in melting and working temperature is known, the inventors have surprisingly found that the lower meting and working temperature of the selected polymers (A) according to the present invention enables to manufacture fluid-system components having an extremely high purity which was not possible when using ETFE and ECTFE polymers with the 50/50 molar ratio between the halogenated ethylene co monomer and ethylene co-monomer.

ECTFE polymers which have been found to give particularly good results are those consisting essentially of recurring units derived from:
(a) from 35 to 47% by moles of ethylene (E);
(b) from 53 to 65% by moles of chlorotrifluoroethylene (CTFE).

For “consisting essentially it is intended that end chains, defects or minor amounts of monomer impurities leading to recurring units different from those above mentioned can be still comprised in the preferred ECTFE, in an amount lower than 1% in moles without this affecting properties of the material.

Polymers (A) as defined above can be prepared with very low levels of impurities using conventional techniques, so that they typically have a very low level of metal contaminants and a low level of TOC (total organic carbon). Normally polymers (A) selected according to the invention will not require special attention in their preparation: polymers (A) manufactured with conventional source ingredients and techniques, known in the art for ETFE and ECTFE manufacturing, have a content in TOC and metal impurities which is sufficiently low to be used in a thermoplastic composition which satisfy the extraction test requirements of the invention. To note, some commercial grades of copolymers in this class contain additives such as antioxidants or UV absorbers which may contribute significantly to the levels of extractable impurities. These grades are not recommended for the present invention.

Thermoplastic polymeric compositions for the present invention have a TOC content, when measured with the extraction test described herein, of less than 5 ppm, preferably less than 4 ppm, more preferably less than 3 ppm.

As mentioned above it is preferred that the thermoplastic composition in the fluid system components of the invention comprises at least 95% wt, preferably at least 99%, and more preferably consists of said one or more semi crystalline polymer (A). In particular in order to avoid further sources of contamination which may impact the suitability of the fluid-system component of the invention for ultra purity applications it is preferred that the thermoplastic polymeric composition is free from additives such as UV filters, antioxidants, surfactants, acid scavengers, metal oxides and salts and the like. Most preferably the polymeric composition of the invention is free from any non polymeric component. In this context for “free of” it is intended that additives and/or non polymeric components may be present at a total level of trace impurity of less than 10 mg/kg, preferably less than 1 mg/kg and more preferably below their detectable limit.

The melt flow rate of the thermoplastic composition of the invention measured following the procedure of ASTM 3275-81 at 225° C. and 2.16 Kg, ranges generally from 0.01 to 75 g/10 min, preferably from 0.1 to 50 g/10 min, more preferably from 0.5 to 30 g/10 min. In a preferred embodiment the melt flow rate of the thermoplastic polymeric composition of the invention is 1 g/10 min under 2.16 kg at a temperature below 255° C. A melt flow rate of 1 g/10 min under 2.16 kg is a typical values at which the thermoplastic composition can be worked with conventional equipment, so that this preferred requirement indicates that the thermoplastic composition of the invention can be melt processed with conventional equipment at a temperature below 255° C.

Fluid-system components in accordance to the present invention can either be entirely made of the thermoplastic polymeric composition of the invention, or they can combine a part made from the thermoplastic polymeric composition of the invention with other parts made from different materials including other plastics, glass, metals, composite materials and mixture thereof. Among fluid-system components in accordance to the present invention, tubings are typically made out of plastics wherein at least the innermost layer contacting the fluid is made from the thermoplastic polymeric composition of the invention, while valves, fittings pumps and mixers often combine parts made from the thermoplastic polymeric composition of the invention with parts made from other materials as described. As mentioned above fluid-system components may leach out chemicals of various nature in particular from the surfaces of such components which are directly in contact with the fluids. Chemical leach from fluid distribution systems components is a common issue in several industries, however in the semiconductor manufacturing facilities, in particular with the extreme miniaturization achieved in the recent years, the issue of contamination is extremely sensitive since even minimal levels of contamination which are considered negligible even in the pharmaceutical industry, can be detrimental for the finished products increasing the amount of out of spec products.

However not necessarily the entire surface of a fluid system component is a “fluid contacting surface” i.e. a surface which will go in contact with the fluid when in use. For example when considering a pipe only the innermost surface of the pipe is a “fluid contacting surface”.

Also, as it can be understood by the skilled person, some parts of the fluid-system components of the invention parts may be constructed as multilayer parts. In this case it is preferred that the layer forming the fluid contacting surface is made from the thermoplastic composition of the invention.

In a preferred embodiment, at least the entire surface of the fluid-system component which goes in contact with the fluid when in use (its “fluid contacting surface”) is made from the thermoplastic composition of the invention.

In a further preferred embodiment the entire plastic portion of the fluid-system component is made of the thermoplastic composition of the invention.

In an embodiment of the invention, the fluid-system components of the invention do not comprise other polymeric material other than the thermoplastic polymeric composition of the invention.

In another aspect, the present invention relates to a method of making a fluid system component comprising the steps of:
a) providing a thermoplastic polymeric composition, said composition comprising one or more semi crystalline polymer, the semi crystalline polymer comprising recurring units derived from ethylene (E) and at least one of chlorotrifluoroethylene (CTFE) and tetrafluoroethylene (TFE) said semi crystalline polymer having a heat of fusion of less than 35 J/g [polymer (A)] wherein said thermoplastic polymeric composition when subject to the extraction test described herein has a leeching of less than 50 ppb, preferably less than 10 ppb, for each of Ca, Fe, K, Na, Zn, Ti, Sn, Ce, Cu, Zr, Bi, Si, Al, Sb.
b) heating said thermoplastic polymeric composition to a temperature T comprised from 180° C. to 255° C. thereby melting said thermoplastic composition
c) forming at least a portion of said-fluid system component from said molten thermoplastic polymeric composition.
Any conventional melt forming method can be used herein, for example molding, extrusion, 3d printing, shaping and so on.

In a further aspect the present invention relates to a method of transporting or containing ultra-pure fluids said method including the step of contacting said ultrapure fluids with one or more fluid-system component as described above. As explained above this method is particularly useful in an electronics manufacturing facility, typically a semiconductor manufacturing facility.

As it will be shown by the experimental data reported below in the experimental section, the inventors surprisingly found that fluid system components according to the invention can have excellent performance in handling ultrapure fluids with extremely low levels of leached metals and TOC. This is due to the specific selection of semi crystalline co-polymers of ethylene and at least one of CTFE or TFE, having a heat of fusion of less than 35 J/g.

Polymers in the same class with higher heat of fusion typically do not withstand melt processing and start decomposing at their melt processing temperatures so that the decomposition products contribute to the leachable organic fraction thus causing an increased TOC. Also the increased processing temperature causes an increased metal content due to the interactions of the materials with the equipment during processing. Commercial materials in the class of ECTFE and ETFE copolymers having a heat of fusion above 35 J/g typically contain antioxidant additives which are able to prevent degradation at the melt processing temperature, however these antioxidant additives cause and significant increase in the levels of extractables making the material unsuitable for ultrapure fluids handling.

The selected polymers for the present invention surprisingly also have a comparable metal content but a lower TOC than commonly used polymers for ultrapure fluids handling such as PVDF.

As a result, fluid system components according to the present invention can be obtained by melt processing of the thermoplastic composition as described above, at a relatively low processing temperature and with conventional techniques such as molding extrusion or 3D printing. The resulting fluid system components present a very low level of extractables in terms of Metal ions and TOC and are therefore suitable for use to transport and contain ultrapure fluids such as those used in the electronics and semiconductor industries without causing the contamination of those fluids.

Should the disclosure of any patents, patent applications, and publications which are incorporated herein by reference conflict with the description of the present application to the extent that it may render a term unclear, the present description shall take precedence.

The invention will be now described with reference to the following examples whose purpose is merely illustrative and not limitative of the scope of the invention.

Standards:

Melting Temperature

The melting temperature is determined by Differential Scanning calorimetry (DSC) at a heating rate of 10° C./min, according to ASTM D 3418.

Heat of Fusion

The heat of fusion of polymer (A) is determined by Differential Scanning calorimetry (DSC) at a heating rate of 10° C./min, according to ASTM D 3418.

Melt Flow Rate

The melt flow rate of the polymer (A), is measured following the procedure of ASTM 3275-81 under 2.16 Kg at the indicated temperature.

Materials Used:

Milli-Q water from Millipore water treatment system.

Polymeric Composition 1 (PC1—According to the invention)

100% ECTFE copolymer with 54% in moles of CTFE recurring units and 46% of Ethylene recurring units. No additives. Mp. 205° C.

Heat of Fusion 23 J/g

MFI=0.8-1.2 g/10 min (225° C., 2.16 kg)

Polymeric Composition 2 (PC2—Comparative)

100% ECTFE copolymer with 50% in moles of CTFE recurring units and 50% of Ethylene recurring units with additives: ethylene-acrylic acid copolymer metal salts notably commercially as Aclyn® grade+antioxidant selected from phosphate derivatives (ADK-260)).

Mp=242° C.

Heat of Fusion 43 J/g

MFI=0.8-1.3 g/10 min (275° C., 2.16 kg)

Polymeric Composition 3 (PC3—Comparative)

100% ECTFE copolymer with 50% in moles of CTFE recurring units and 50% of Ethylene recurring units with additives: DSTDP Di Stearyl Thio-Di-Propionate+phosphate derivative antioxidant (ADK-260))

MP=242° C.

Heat of Fusion 43 J/g

MFI=0.8-1.3 g/10 min (275° C., 2.16 kg)

PVDF Solef® 1010S/0001 commercial grade polyvinylidene fluoride polymer from Solvay.

### Measurement of Leeching Via Extraction Test

The thermoplastic polymeric composition under testing is melted in a double screw 27 mm LEISTRITZ extruder having an L/D ratio of 40, and extruded through a 4 mm 2 circular die. The temperature profile of the extruder must be set so that the temperature measured at the extrusion die should be about 30° C. +/−5° C. higher than the melting temperature of the polymeric composition (or of the highest melting temperature in case more DSC peaks are present). A skilled person will know how to adjust the other parameters of the extruder accordingly. The extrusion speed is not critical however the melted composition should not reside in the extruder for very long time to avoid contamination from the extruder materials, therefore screw speed and torque must be set so to extrude the polymeric composition at a speed of from about 5 kg/h to 40 kg/h. The extruded strands having a diameter of about 2 mm (+/−0.2 mm) are cooled in a water bath, dried and cut in pellets of about 1 mm length. The resulting pellets are used for the following testing.

In a ISO 5-7 Clean room 60 ml Nalgene Narrow Mouth Bottle containers (PP cod. 2006-0002) from VWR are washed 3 times with Milli-Q water for 10 seconds for each wash. 20 g of pellets of are weighed in each container. The pellets were then washed adding Milli-Q water until approx. ¾ th of the container, the container then was shaken by hand for 30 seconds and the water is removed. The washing operation is repeated 5 times.

20 g of Milli-Q water is then added and the sample was kept in a closed container in an oven for 7 days at 85° C.

The water after aging is then sampled and tested for cations and TOC.

Metals are measured using ICP-MS and reported as ppb of concentration in the aged water.

TOC is measured according to ASTM D7573-18a and reported as ppm of

TOC concentration in the aged water.

TABLE 1
Metals

| ppb | PC1 | PC2* | PC3* |
|---|---|---|---|
| Ca | 1.7 | 4.5 | 5.3 |
| Fe | 2.3 | 15 | 9.5 |
| K | 1.6 | 16 | 18 |
| Na | 1.5 | 3.2 | 9.5 |
| Zn | 0.8 | 1.1 | 10.9 |

TABLE 2
TOC

| | | | | PVDF* |
|---|---|---|---|---|
| ppm | PC1 | PC2* | PC3* | Solef ® 1010S/0001 |
| TOC | 2.2 | 5 | 5 | 12 |

*comparative

1. A fluid-system component comprising:
a thermoplastic polymeric composition,
said composition comprising one or more semi crystalline polymer, polymer (A), said semi crystalline polymer comprising recurring units derived from ethylene (E) and at least one of chlorotrifluoroethylene (CTFE) and tetrafluoroethylene (TFE);
said semi crystalline polymer having a heat of fusion of less than 35 J/g;
wherein said thermoplastic polymeric composition when subject to an extraction test has a leeching of less than 50 ppb for each of Ca, Fe, K, Na, Zn, Ti, Sn, Ce, Cu, Zr, Bi, Si, Al, Sb.

2. A fluid system component according to claim 1 wherein said thermoplastic polymeric composition comprises at least 95% wt of said one or more semi crystalline polymer (A).

3. A fluid system component according to claim 1 wherein said one or more polymer (A) comprises more than 95% in moles of recurring units derived from ethylene, CTFE and TFE.

4. A fluid system component according to claim 1 wherein said one or more polymer (A) comprise an amount of recurring units derived from ethylene of less than 50% moles.

5. A fluid system component according to claim 1 wherein said one or more polymer (A) comprise:
(a) from 30 to 48% by moles of ethylene (E);
(b) from 52 to 70% by moles of chlorotrifluoroethylene (CTFE), tetrafluoroethylene (TFE) or mixture thereof; and
(c) from 0 to 5% by moles, based on the total amount of monomers (a) and (b), of one or more fluorinated and/or hydrogenated comonomer(s).

6. A fluid system component according to claim 1 wherein said one or more polymer (A) is selected from copolymers of ethylene, CTFE and, optionally from 0 to 5% by moles, based on the total amount of ethylene and CTFE monomers, of one or more fluorinated and/or hydrogenated comonomer(s).

7. A fluid system component according to claim 5 wherein said hydrogenated comonomer is selected from the group consisting of the (meth)acrylic monomers.

8. A fluid system component according to claim 1 wherein said one or more polymer (A) has a melting temperature comprised between 150° C. and 230° C.

9. A fluid system component according to claim 1 wherein said thermoplastic polymeric composition has a melt flow rate of 1 g/10 min under 2.16 kg at a temperature below 255° C.

10. A fluid system component according to claim 1 wherein said thermoplastic polymeric composition has a TOC of less than 5 ppm.

11. A fluid system component according to claim 1 wherein said thermoplastic polymeric composition is free from UV filters, antioxidants, acid scavengers, metal oxides and salts.

12. A fluid system component according to claim 1 wherein said fluid system component is selected from the group consisting of pipes, valves, fittings, pumps, manifolds, regulators, pressure regulators, static mixers, gauge protectors, filter housings, o-rings and wet benches.

13. A fluid system component according to claim 1 having a fluid contacting surface and wherein at least the entire fluid contacting surface is made of said thermoplastic polymeric composition.

14. A method of making a fluid-system component, the method including the following steps:
a) providing a thermoplastic polymeric composition, said composition comprising one or more semi crystalline polymer, polymer (A), said semi crystalline polymer comprising recurring units derived from ethylene (E) and at least one of chlorotrifluoroethylene (CTFE) and tetrafluoroethylene (TFE);
said semi crystalline polymer having a heat of fusion of less than 35 J/g;
wherein said thermoplastic polymeric composition when subject to the extraction test described herein has a leeching of less than 50 ppb for each of Ca, Fe, K, Na, Zn, Ti, Sn, Ce, Cu, Zr, Bi, Si, Al, Sb,
b) heating said thermoplastic polymeric composition to a temperature T comprised from 150° C. and 255° C. thereby melting said thermoplastic composition, and
c) forming at least a portion of said-fluid system component from said molten thermoplastic polymeric composition.

15. A method of transporting or containing ultra-pure fluids said method including the step of contacting said ultrapure fluids with one or more fluid-system component according to claim 1.

16. A fluid system component according to claim 1 wherein said thermoplastic polymeric composition comprises at least 99% of said one or more semi crystalline polymer (A).

17. A fluid system component according to claim 1 wherein said one or more polymer (A) comprise an amount of recurring units derived from ethylene of less than 48% moles.

18. A fluid system component according to claim 1 wherein said one or more polymer (A) comprise from 55 to 65% by moles of chlorotrifluoroethylene (CTFE), tetrafluoroethylene (TFE) or mixture thereof.

19. A fluid system component according to claim 5 wherein said one or more polymer (A) comprise from 0 to 2.5% by moles, based on the total amount of monomers (a) and (b), of one or more fluorinated and/or hydrogenated comonomer(s).

20. A fluid system component according to claim 1 wherein said thermoplastic polymeric composition has a TOC of less than 4 ppm.
